(19) United States
(12) Patent Application Publication
(10) Pub. No.: US 2014/0107863 A1
(43) Pub. Date: Apr. 17, 2014

(54) Vehicle Control Device, Vehicle Control System

(71) Applicants: Tasuku Ishigooka, Tokyo (JP); Fumio Narisawa, Tokyo (JP); Tsunamichi Tsukidate, Tokyo (JP); Wataru Nagaura, Hitachinaka (JP); Hidetoshi Ogura, Hitachinaka (JP)

(72) Inventors: Tasuku Ishigooka, Tokyo (JP); Fumio Narisawa, Tokyo (JP); Tsunamichi Tsukidate, Tokyo (JP); Wataru Nagaura, Hitachinaka (JP); Hidetoshi Ogura, Hitachinaka (JP)

(73) Assignee: Hitachi Automotive Systems, Ltd., Hitachinaka-shi, Ibaraki (JP)

(21) Appl. No.: 14/124,149

(22) PCT Filed: Jun. 4, 2012
(86) PCT No.: PCT/JP2012/064360

§ 371 Date: Dec. 5, 2013

(30) Foreign Application Priority Data
Jun. 9, 2011 (JP) 2011-129535

(51) Int. Cl. G05D 1/00

(52) U.S. Cl. CPC G05D 1/00
USPC 701/1

(57) ABSTRACT

Provided is a technology for performing communications between ECUs with different required safety levels while satisfying the required safety levels of the ECUs. An automotive control unit according to the present invention modifies the error detection method used for data transmission in accordance with the required degree of accuracy of operation of the receiving-end unit (as per FIG. 2).

### TECHNICAL FIELD

The present invention relates to a technology for performing communications between automotive control units.

### BACKGROUND ART

Many of the recent automotive control systems include an electronic control unit (ECU) for operating electronic vehicle control devices, and an on-board local area network (LAN) for enabling communications between a plurality of ECUs. One example of the on-board LAN that is widely used is a controller area network (CAN).

In automotive control systems, in order to prevent unintended alteration of communication data (data corruption), a data corruption detection method for detecting data corruption is used. The data corruption detection method includes parity checking, cyclic redundancy check (CRC), and checksums, for example.

A transmitting ECU calculates an error-detecting code from data to be transmitted, according to an adopted data corruption detection method, and transmits the data in a set with the error-detecting code. A receiving ECU calculates an error-detecting code from the received data by using the same data corruption detection method as in the transmitting ECU, and compares the calculated error-detecting code with the received error-detecting code. If the error-detecting codes match, there is no data corruption; if they do not match, there is data corruption.

In recent years, it has become increasingly important that the automotive control system is assured to operate normally and not to inflict injury to people as much as possible, and that the assurance is accountable. Specifically, in order to prevent injury to people by an unintended activation of a function, for example, it is necessary to assign safety levels to individual functions and to develop the automotive control system such that the safety levels are met.

The safety levels indicate the degrees of safety to be observed, and may be determined by the magnitude and the like of damage that may result if the particular function failed to operate normally. For example, four safety levels are defined, with higher safety levels assigned to functions with greater risk of damage in case of failure to operate accurately. The developer sets a data corruption detection rate to be detected for each safety level, and develops the automotive control system such that the data corruption detection rate is achieved. The safety levels may be assigned to each function of the ECUs or to each ECU. In the case of a function that is implemented by performing communications between a plurality of ECUs, the safety levels may be assigned to combinations of communicating functions.

In a technology described in Patent Literature 1 indicated below, a control unit calculates a communication error rate and the like each time data is received, and switches the data corruption detection method in accordance with the error rate when the data is transmitted. By switching the data corruption detection method in accordance with the communication environment (transmission path state), reliable communication can be performed.

In a technology described in Patent Literature 2 indicated below, a receiving unit calculates reliability information from the communication environment, and notifies a transmitting unit of a coding rate based on the reliability information. The notified transmitting unit encodes the data corruption detection method by using the received coding rate, whereby reliable communication can be performed.

### CITATION LIST

### Patent Literature

Patent Literature 1: JP Patent Publication (Kokai) No. 2008-42338 A

Patent Literature 2: JP Patent Publication (Kokai) No 2003-69531 A

### SUMMARY OF INVENTION

### Technical Problem

Because an automotive control system implements highly sophisticated control involving the coordination of the functions of different ECUs, communications between the ECUs with different required safety levels must be performed while a data corruption detection rate according to a higher safety level is ensured.

According to the technology described in Patent Literature 1, the data corruption detection method can be switched in accordance with the error rate in communication and the like. However, the data corruption detection method cannot be switched in accordance with the safety level assigned on the ECU or functional unit basis.

According to the technology described in Patent Literature 2, highly reliable communications can be performed by increasing the coding rate even when the communication environment deteriorates. However, as in the above Patent Literature 1, the data corruption detection method cannot be switched in accordance with the safety level assigned on the ECU or functional unit basis.

The present invention was made in order to overcome the above problem, and an objective of the present invention is to provide a technology for performing communications between ECUs with different required safety levels while satisfying the required safety level of each ECU.

### Solution to Problem

An automotive control unit according to the present invention modifies the error detection method used for data transmission in accordance with the required degree of accuracy of operation of a receiving-end unit.

### Advantageous Effects of Invention

The automotive control unit according to the present invention selects the data corruption detection method in accordance with the required degree of accuracy of operation of the receiving ECU. Thus, communications between ECUs with different safety levels can be performed while the required safety levels are ensured.

### BRIEF DESCRIPTION OF DRAWINGS

FIG. 1 is a configuration diagram of an automotive control system 1000 according to Embodiment 1.

FIG. 2 is a configuration diagram of a camera ECU 1.

FIG. 3 is a configuration diagram of a following distance control ECU 2.

FIG. 4 is a configuration diagram of a pre-crash safety control ECU 3.

FIG. 5 is a configuration diagram of a brake control ECU 4.

FIG. 6 illustrates an example of a communication data management table 112 provided in the camera ECU 1.

FIG. 7 illustrates an example of a required level determination table 113 provided in the camera ECU 1.

FIG. 8 illustrates an example of a detection method selection table 114 provided in the camera ECU 1, the following distance control ECU 2, and the pre-crash safety control ECU 3.

FIG. 9 illustrates an example of a communication data management table 212 provided in the following distance control ECU 2.

FIG. 10 illustrates an example of a required level determination table 213 provided in the following distance control ECU 2.

FIG. 11 illustrates an example of a reception buffer 214 provided in the following distance control ECU 2.

FIG. 12 illustrates an example of a communication data management table 312 provided in the pre-crash safety control ECU 3.

FIG. 13 illustrates an example of a required level determination table 313 provided in the pre-crash safety control ECU 3.

FIG. 14 illustrates an example of a reception buffer 314 provided in the pre-crash safety control ECU 3.

FIG. 15 illustrates an example of a reception buffer 408 provided in the brake control ECU 4.

FIG. 16 illustrates an operation flow of a camera control unit 104 provided in the camera ECU 1.

FIG. 17 illustrates an operation flow of a communication processing unit 105 provided in the camera ECU 1.

FIG. 18 illustrates an operation flow of a required operation accuracy level determination unit 106.

FIG. 19 illustrates an operation flow of a data corruption detection method selection unit 107.

FIG. 20 illustrates a structure of error detecting code-attached transmission data 510.

FIG. 21 illustrates an operation flow of a parity data creation unit 108.

FIG. 22 illustrates an operation flow of a CRC code creation unit 109.

FIG. 23 illustrates an operation flow of a communication control unit (transmission process) 110.

FIG. 24 illustrates an operation flow of a following distance control unit 204 provided in the following distance control ECU 2.

FIG. 25 illustrates an operation flow of a communication control unit (reception process) 210.

FIG. 26 illustrates an operation flow of a parity data detection unit 208.

FIG. 27 illustrates an operation flow of a pre-crash safety control unit 304 provided in the pre-crash safety ECU 3.

FIG. 28 illustrates an operation flow of a CRC code detection unit 308.

FIG. 29 illustrates an operation flow of a brake control unit 404.

FIG. 30 illustrates a data frame 520 that uses CAN as a communication protocol.

### DESCRIPTION OF EMBODIMENTS

### Embodiment 1

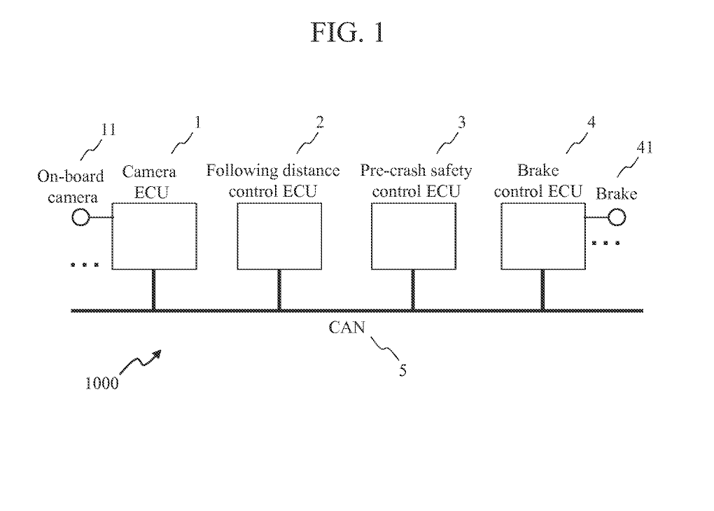

FIG. 1 is a configuration diagram of an automotive control system 1000 according to Embodiment 1 of the present invention. The automotive control system 1000 includes one or more ECUs for controlling a vehicle that are connected by a network.

The ECUs control various parts of the vehicle and communicate with each other as needed. For example, a camera ECU 1 recognizes an environmental situation by using an on-board camera 11, and transmits following distance data to a CAN 5. A following distance control ECU 2 receives the following distance data, calculates brake torque data by using the following distance data, and transmits the brake torque data to the CAN 5. A pre-crash safety control ECU 3 receives the following distance data, and determines the possibility of collision by using the following distance data. When the collision possibility is high, the pre-crash safety control ECU 3 transmits quick braking request data to the CAN 5. A brake control ECU 4 receives the brake torque data and the quick braking request data, and controls a brake 41 in accordance with the data.

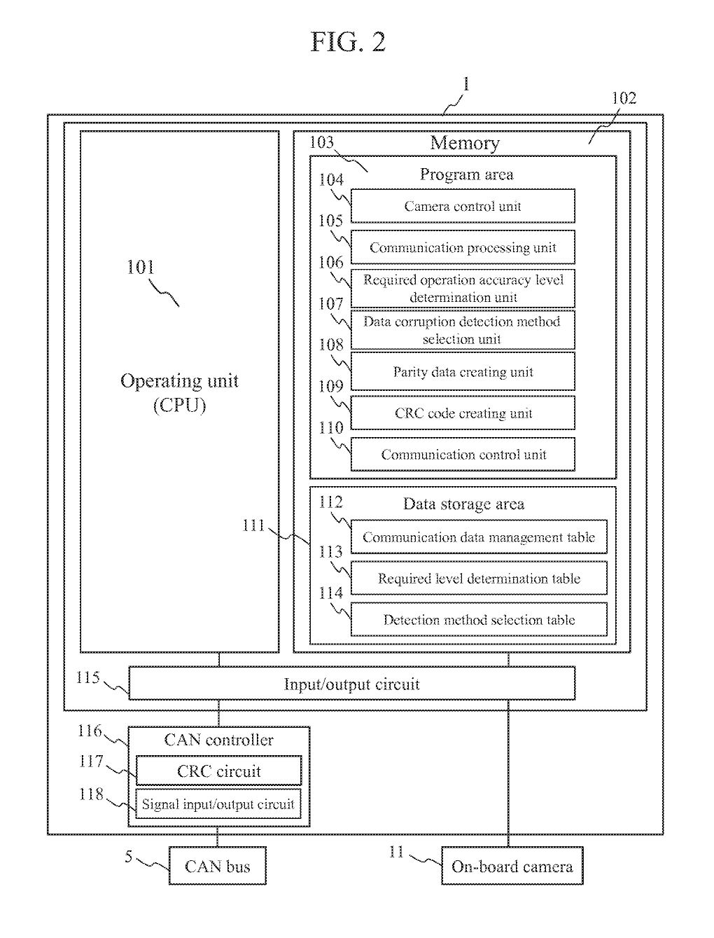

FIG. 2 is a configuration diagram of the camera ECU 1. The camera ECU 1 includes an operating unit 101, a memory 102, an input/output circuit 115, and a CAN controller 116.

The operating unit 101 is a processor (central processing unit) that executes various programs stored in the memory 102. The equivalent function may be configured by using hardware, such as a circuit device.

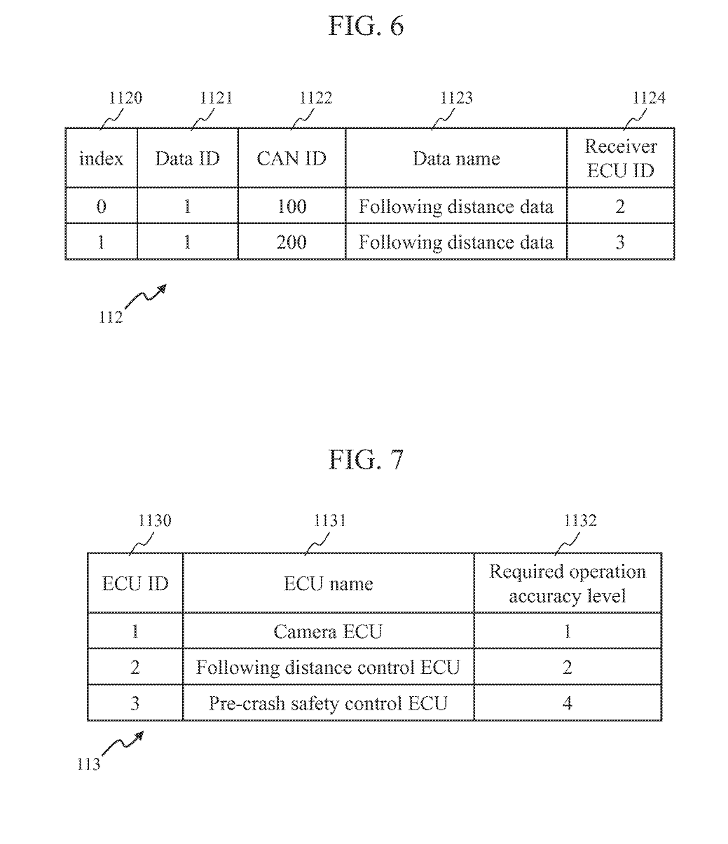

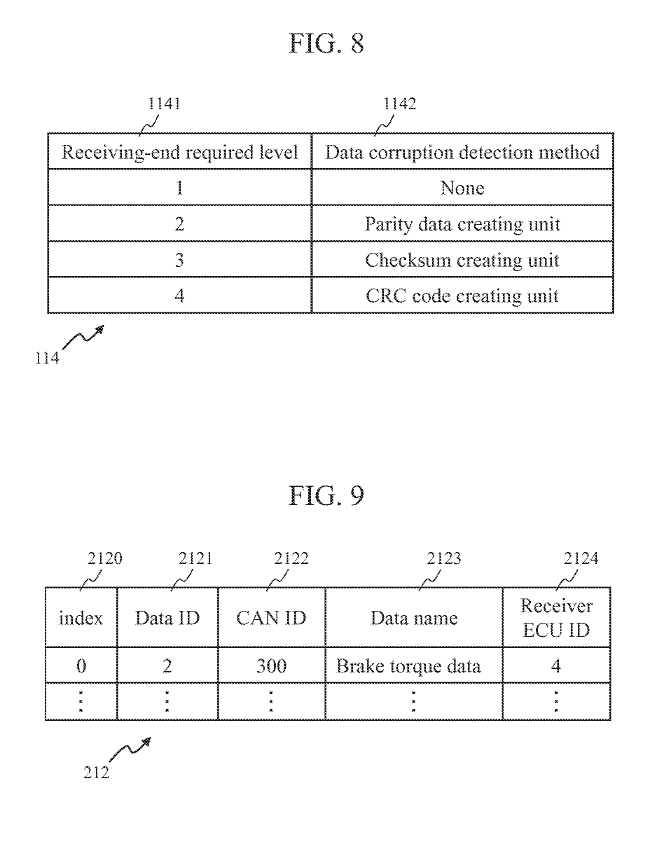

The memory 102 includes a program area 103 and a data storage area 111. The program area 103 stores a camera control unit 104, a communication processing unit 105, a required operation accuracy level determination unit 106, a data corruption detection method selection unit 107, a parity data creation unit 108, a CRC code creation unit 109, and a communication control unit 110. The functions of these programs will be described below. The data storage area 111 stores a communication data management table 112 which will be described below with reference to FIG. 6, a required level determination table 113 which will be described with reference to FIG. 7, and a detection method selection table 114 Which will be described with reference to FIG. 8.

The CAN controller 116 includes a CRC circuit 117 and a signal input/output circuit 118. The CRC circuit 117 calculates a CRC code by using data to be transmitted to the CAN bus 5, attaches the CRC code to a communication packet, and transmits the data to the CAN bus 5. The CRC circuit 117 also calculates a CRC code by using data received from the CAN bus 5, and compares a received CRC code with the calculated CRC code to detect data corruption. The signal input/output circuit 118 performs required processes as needed, such as a process of converting a communication signal received from the CAN bus 5 into digital form.

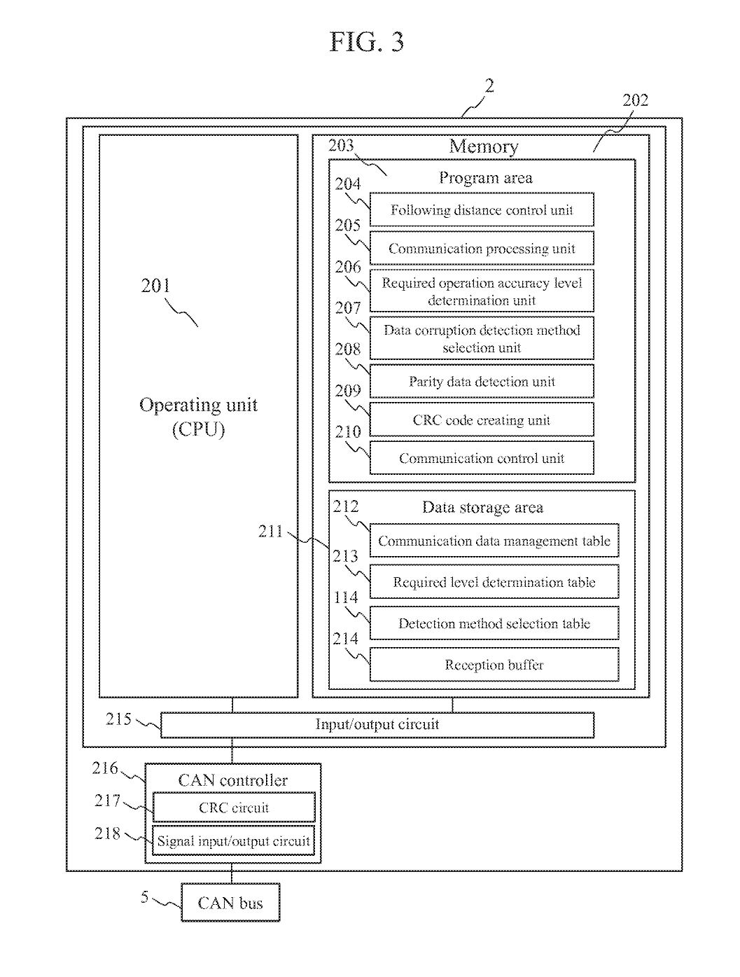

FIG. 3 is a configuration diagram of the following distance control ECU 2. The following distance control ECU 2 includes an operating unit 201, a memory 202, an input/output circuit 215, and a CAN controller 216.

The operating unit 201 is a processor that executes programs stored in the memory 202. The equivalent function may be configured by using hardware, such as a circuit device.

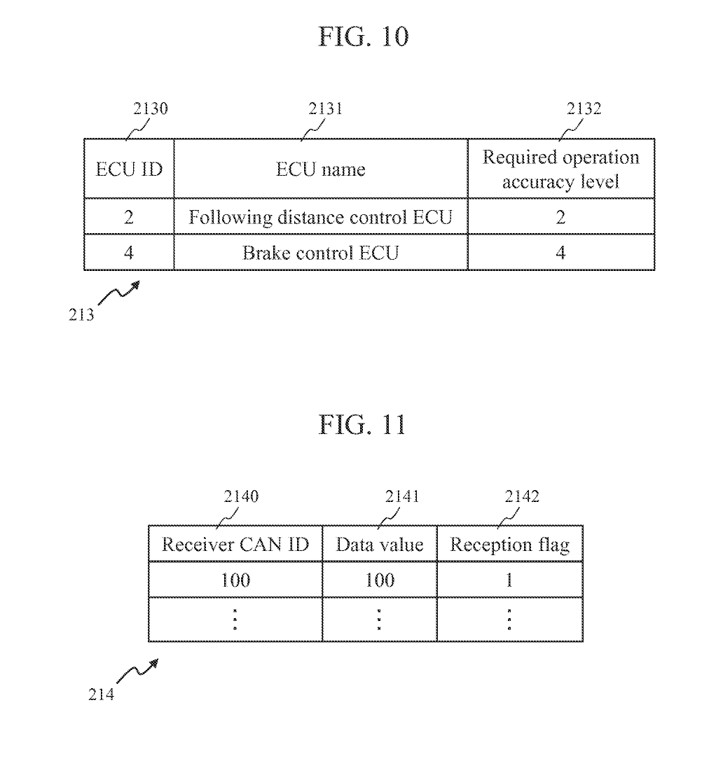

The memory 202 includes a program area 203 and a data storage area 211. The program area 203 stores a following distance control unit 204, a communication processing unit 205, a required operation accuracy level determination unit 206, a data corruption detection method selection unit 207, a parity data detection unit 208, a CRC code creation unit 209, and a communication control unit 210. The functions of these programs will be described below. The data storage area 211 stores a communication data management table 212 which will be described below with reference to FIG. 9, a required level determination table 213 which will be described with reference to FIG. 10, the detection method selection table 114 which will be described with reference to FIG. 8, and a reception buffer 214 which will be described with reference to FIG. 11.

The configuration of the CAN controller 216 is similar to the configuration of the CAN controller 116 provided in the camera ECU 1.

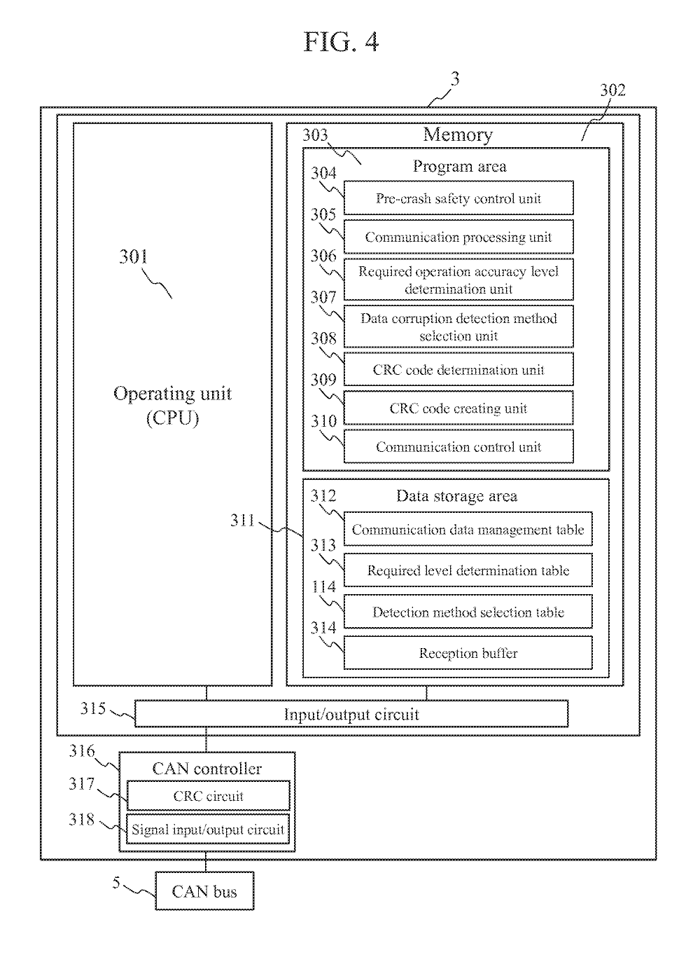

FIG. 4 is a con a ion diagram of the pre-crash safety control ECU 3. The pre-crash safety control ECU 3 includes an operating unit 301, a memory 302, an input/output circuit 315, and a CAN controller 316.

The operating unit 301 is a processor that executes programs stored in the memory 302. The equivalent function may be configured by using hardware, such as a circuit device.

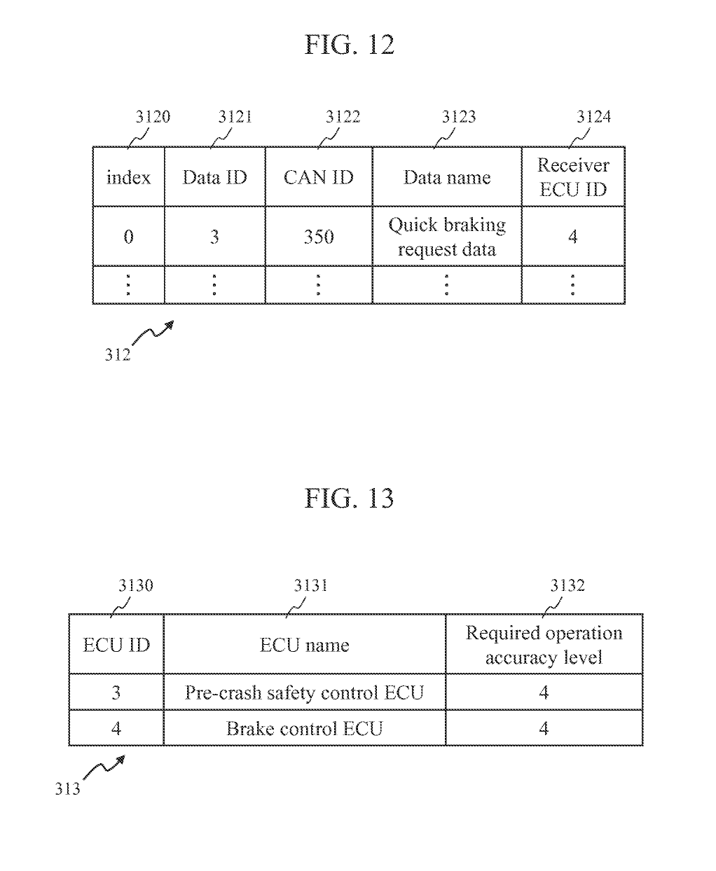

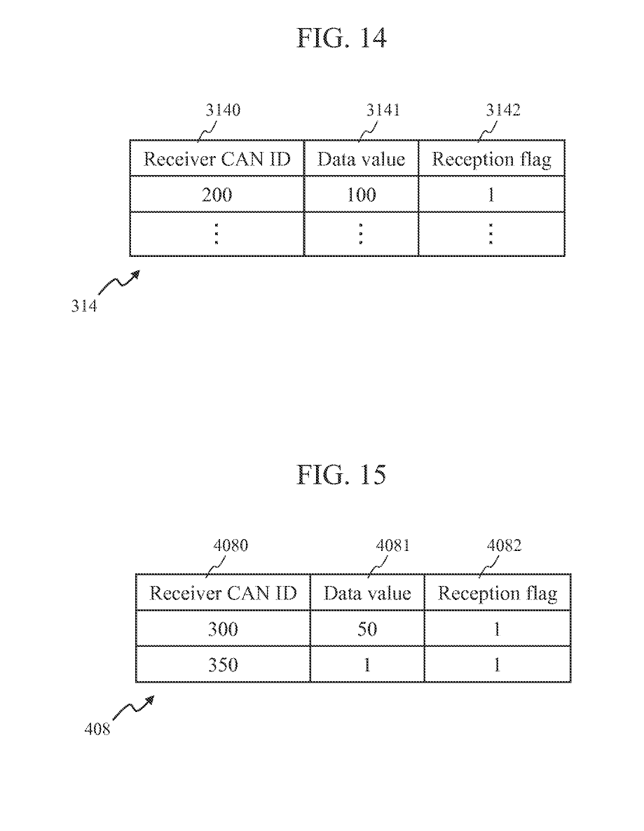

The memory 302 includes a program area 303 and a data storage area 311. The program area 303 stores a pre-crash safety control unit 304, a communication processing unit 305, a required operation accuracy level determination unit 306, a data corruption detection method selection unit 307, a CRC code detection unit 308, a CRC code creation unit 309, and a communication control unit 310. The functions of these programs will be described below. The data storage area 311 stores a communication data management table 312 which will be described below with reference to FIG. 12, a required level determination table 313 which will be described with reference to FIG. 13, the detection method selection table 114 Which will be described with reference to FIG. 8, and a reception buffer 314 which will be described with reference to FIG. 14.

The configuration of the CAN controller 316 is similar to the configuration of the CAN controller 116 provided in the camera ECU 1.

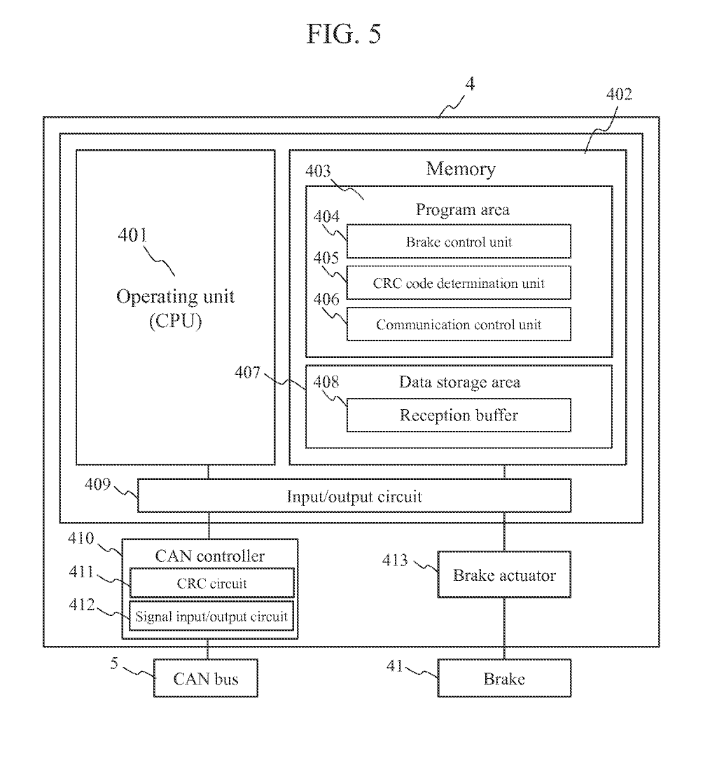

FIG. 5 is a configuration diagram of the brake control ECU 4. The brake control ECU 4 includes an operating unit 401, a memory 402, an input/output circuit 409, a CAN controller 410, and a brake actuator 413 that controls the brake 41.

The operating unit 401 is a processor that executes programs stored in the memory 402. The equivalent function may be configured by using hardware, such as a circuit device.

The memory 402 includes a program area 403 and a data storage area 407. The program area 403 stores a brake control unit 404, a CRC code detection unit 405, and a communication control unit 406. The functions of these programs will be described below. The data storage area 407 stores a reception buffer 408 which will be described below with reference to FIG. 15.

The configuration of the CAN controller 410 is similar to the configuration of the CAN controller 116 provided in the camera ECU 1.

FIG. 6 illustrates an example of the communication data management table 112 provided in the camera ECU 1. The communication data management table 112 is a table for managing the type of data transmitted by the camera ECU 1, and includes an index field 1120, a data ID field 1121, a CAN ID field 1122, a data name field 1123, and a receiver ECU ID field 1124.

The index field 1120 retains numbers identifying records. The data ID field 1121 retains values identifying the type of data transmitted by the camera ECU 1. The CAN ID field 1122 retains the CAN ID of the data transmitted by the camera ECU 1. The data name field 1123 retains the names of the data transmitted by the camera ECU 1. The receiver ECU ID field 1124 retains identifiers of ECUs as data destinations.

FIG. 7 illustrates an example of the required level determination table 113 provided in the camera ECU 1. The required level determination table 113 is a table used for determining the required degree of accuracy of operation of the destination ECU to which the camera ECU transmits control data, and includes an ECU ID field 1130, an ECU name field 1131, and a required operation accuracy level field 1132.

The ECU ID field 1130 retains identifiers identifying the ECUs in the automotive control system 1000. The ECU name field 1131 retains the names of the ECUs identified by the ECU ID field 1130. The required operation accuracy level field 113 retains values indicating the required degrees of accuracy of operation of the ECUs identified by the ECU ID field 1130. The higher the value in this field, the higher the required level of accuracy of operation is.

If an ECU operates accurately, it means that the ECU operates according to design. ECUs that have greater influence on safety in the event of failure to operate accurately require higher accuracy of operation, and therefore have higher values in the required operation accuracy level field 1132.

FIG. 8 illustrates an example of the detection method selection table 114 provided in the camera ECU 1, the following distance control ECU 2, and the pre-crash safety control ECU 3. The detection method selection table 114 is a table used for selecting a data corruption detection method in accordance with the required operation accuracy level required in the receiving-end ECU, and includes a receiving-end required level field 1141, and a data corruption detection method 1142.

The receiving-end required level field 1141 lists the values of required operation accuracy levels required in the receiving-end ECU. The data corruption detection method 1142 retains values designating the data corruption detection methods suitable for the values in the receiving-end required level field 1141.

FIG. 9 illustrates an example of the communication data management table 212 provided in the following distance control ECU 2. The configuration of the communication data management table 212 is similar to the configuration of the communication data management table 112 provided in the camera ECU 1; however, the contents of the retained records correspond to the control data transmitted by the following distance control ECU 2.

FIG. 10 illustrates an example of the required level determination table 213 provided in the following distance control ECU 2. The configuration of the required level determination table 213 is similar to the configuration of the required level determination table 113 provided in the camera ECU 1; however, the contents of the retained records correspond to the destination of the control data transmitted by the following distance control ECU 2.

FIG. 11 illustrates an example of the reception buffer 214 provided in the following distance control ECU 2. The reception buffer 214 is a buffer for temporarily storing the data received by the following distance control ECU 2, and includes a reception CAN ID field 2140, a data value field 2141, and a reception flag field 2142.

The reception CAN ID field 2140 retains the CAN ID of the received data. The data value field 2141 retains the value of the received data. The reception flag field 2142 retains flag values indicating whether data has been received from the CAN bus 5.

FIG. 12 illustrates an example of the communication data management table 312 provided in the pre-crash safety control ECU 3. The configuration of the communication data management table 312 is similar to the configuration of the communication data management table 112 provided in the camera ECU 1; however, the contents of the retained records correspond to the control data transmitted by the pre-crash safety control ECU 3.

FIG. 13 illustrates an example of the required level determination table 313 provided in the pre-crash safety control ECU 3. The configuration of the required level determination table 313 is similar to the configuration of the required level determination table 113 provided in the camera ECU 1; however, the contents of the retained records correspond to the destination of the control data transmitted by the pre-crash safety control ECU 3.

FIG. 14 illustrates an example of the reception buffer 314 provided in the pre-crash safety control ECU 3. The configuration of the reception buffer 314 is similar to the configuration of the reception buffer 214 provided in the following distance control ECU 2; however, the contents of the retained records correspond to the data received by the pre-crash safety control ECU 3.

FIG. 15 illustrates an example of the reception buffer 408 provided in the brake control ECU 4. The configuration of the reception buffer 408 is similar to the configuration of the reception buffer 214 provided in the following distance control ECU 2; however, the contents of the retained records correspond to the data received by the brake control ECU 4.

The configuration of each of the devices of the automotive control system 1000 has been described. In the following, the operation flow of each device will be described with reference to a process in which the camera ECU 1 calculates a following distance by using the on-board camera 11, and transmits following distance data to the CAN 5.

When the receiving ECU is the following distance control ECU 2, since the required operation level of the following distance control ECU 2 is “2”, the camera ECU 1 calculates the error-detecting code by using parity data as the data corruption detection method, and transmits the error-detecting code in a set with the following distance data. When the receiving ECU is the pre-crash safety control ECU 3, since the required operation level of the pre-crash safety control ECU 3 is “4”, the camera ECU 1 calculates the error-detecting code by using CRC as the data corruption detection method, and transmits the error-detecting code in a set with the following distance data.

The following distance control ECU 2 calculates brake torque in accordance with the value of the received following distance data, and transmits brake torque data to the brake control ECU 4, using CRC as the data corruption detection method.

The pre-crash safety control ECU 3 determines whether to issue a quick braking request in accordance with the value of the received following distance data, and transmits quick braking request data to the brake control ECU 4, using CRC as the data corruption detection method.

The brake control ECU 4 controls the brake 41 in accordance with. the received brake torque data and quick braking request data.

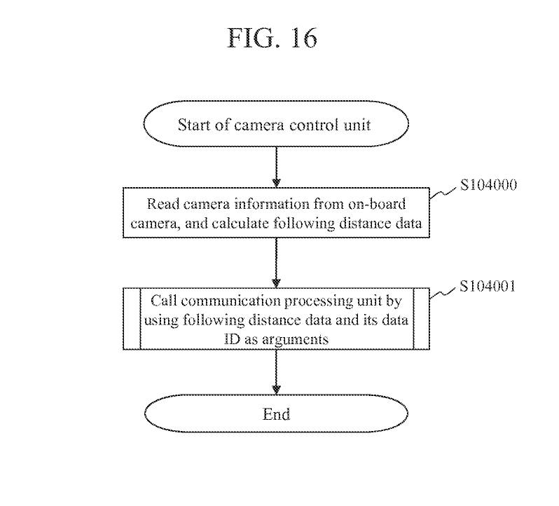

FIG. 16 is a flow chart of operation of the camera control unit 104 provided in the camera ECU 1. In the following, each step of FIG. 16 will be described.

### (FIG. 16: Step S104000)

The camera control unit 104 reads picture data obtained by the on-board camera 11, and calculates following distance data based on the picture data.

### (FIG. 16: Step S104001)

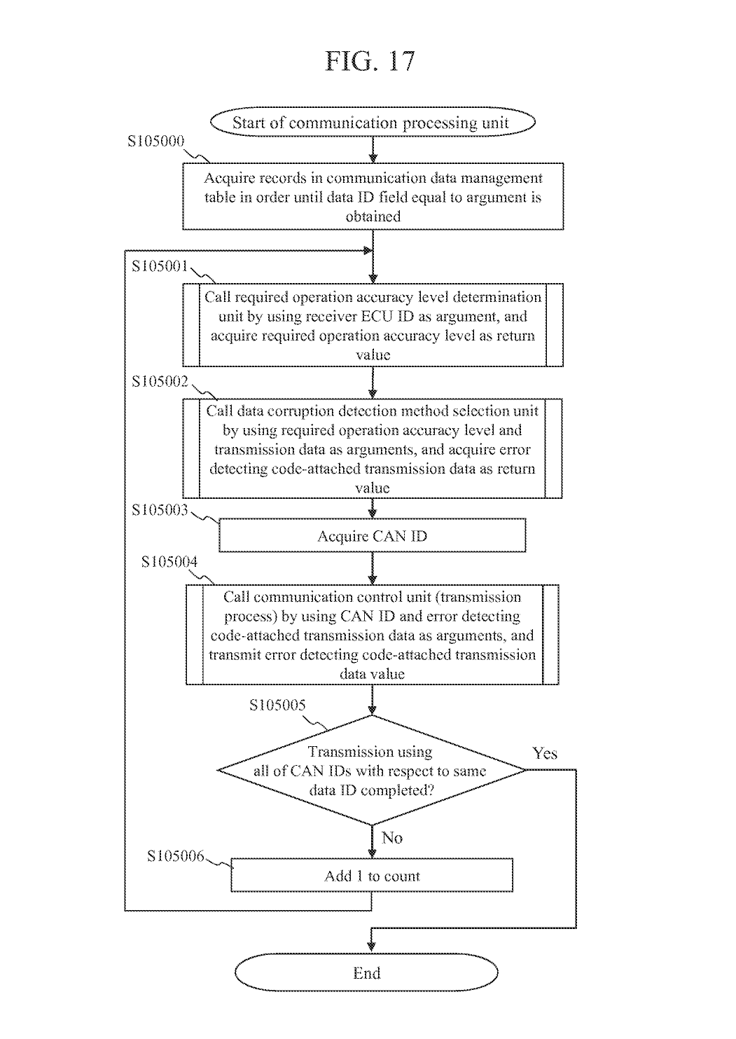

The camera control unit 104 calls the communication processing unit 105 by using the following distance data and its data ID as arguments and transmits the following distance data, and the present operation flow ends. For example, when the data ID of the following distance data is “1”, the camera control unit 104 calls the communication processing unit 105 by using the following distance data value and the data ID “1” as the arguments. The details of the present step will be described with reference to FIG. 17.

FIG. 17 is a flow chart of operation of the communication processing unit 105 provided in the camera ECU 1. A similar operation flow is implemented by the communication processing unit 205 and the communication processing unit 305. In the following, each step of FIG. 17 will be described.

### (FIG. 17: Step SS105000)

The communication processing unit 105 sets the variable “count” for storing the value of the index field 1120 of the communication data management table 112 to “0”. The communication processing unit 105 acquires the records in the communication data management table 112 sequentially while incrementing the value of the variable count by one until the data ID field 1121 equal to the received argument is obtained.

### (FIG. 17: Step S105001)

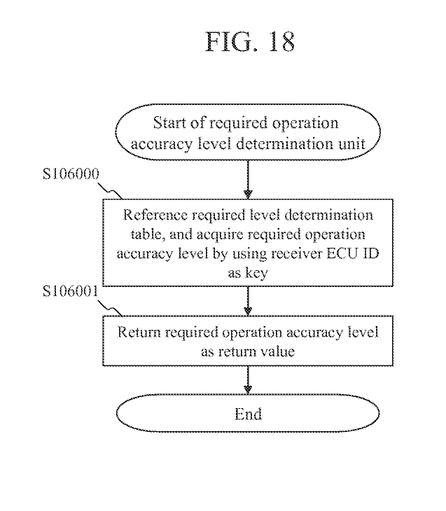

The communication processing unit 105 references the record in the communication data management table 112 corresponding to the value of the variable count, and acquires the receiver ECU ID field 1124. The communication processing unit 105 calls the required operation accuracy level determination unit 106 by using the acquired value of the receiving ECU ID field 1124 as an argument, and acquires the value of the required operation accuracy level as a return value. For example, in the data example described with reference to FIG. 6, when the count (=index) is “0”, the receiver ECU ID field 1124 is “2”. Thus, the required operation accuracy level determination unit 106 is called by designating “2” as the argument. The details of the present step will be described with reference to FIG. 18.

### (FIG. 17: Step S105002)

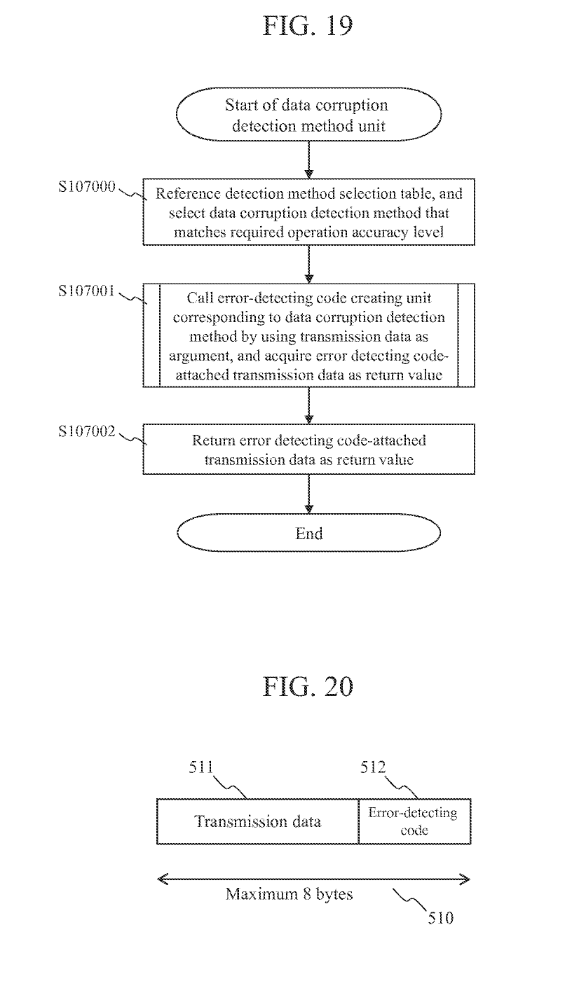

The communication processing unit 105 calls the data corruption detection method selection unit 107 by using as arguments the acquired required operation accuracy level and the data received as an argument to the communication processing unit 105, and acquires error detecting code-attached transmission data as a return value. For example, in the data example described with reference to FIG. 7, when the data that the communication processing unit 105 has received as an argument is the following distance data, and the data is to be transmitted to the following distance control ECU 2, the data corruption detection method selection unit 107 is called by using the required operation accuracy level “2” and the following distance data value as the arguments. Similarly, when the data that the communication processing unit 105 has received as an argument is the following distance data, and the data is to be transmitted to the pre-crash safety control ECU 4, the data corruption detection method selection unit 107 is called by using the required operation accuracy level “4” and the following distance data value as the arguments. The details of the present step will be described with reference to FIG. 19.

### (FIG. 17: Step S105003)

The communication processing unit 105 references the communication data management table 112, and acquires the CAN ID field 1122 of the record corresponding to the count value. For example, in the data example described with reference to FIG. 6, when the count (=index) is “0”, “100” is acquired as the value of the CAN ID field 1122.

### (FIG. 17: Step SS105004)

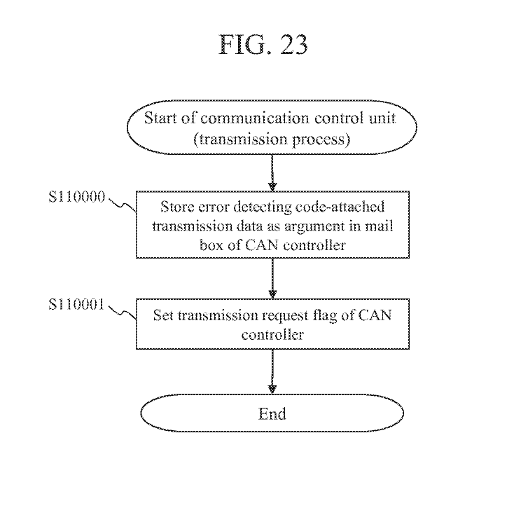

The communication processing unit 105 calls the communication control unit (transmission process) 110 by using the CAN ID acquired in step S105003 and the error detecting code-attached transmission data acquired in step S105002 as arguments, and transmits an error detecting code-attached transmission data value. The details of the present step will be described with reference to FIG. 23.

### (FIG. 17: Step S105005)

The communication processing unit 105 determines whether transmission has been completed using all of CAN IDs with respect to the same data ID. If the transmission is completed, the present operation flow ends. If the transmission is not completed, the operation flow proceeds to step S105006. For example, the communication processing unit 105 determines that the transmission is completed when the count is “1”, while the communication processing unit 205 and the communication processing unit 305 determine that the transmission is completed when the count is “0”.

### (FIG. 17: Step S105006)

The communication processing unit 105 adds “1” to the count value, and then returns to step S105001.

FIG. 18 is a flow chart of operation of the required operation accuracy level determination unit 106. A similar operation flow is implemented by the required operation accuracy level determination unit 206 and the required operation accuracy level determination unit 306. In the following, each step of FIG. 18 will be described.

### (FIG. 18: Step S106000)

The required operation accuracy level determination unit 106 references the required level determination table 113 and acquires the required operation accuracy level field 1132 front the record of which the value in the ECU ID field 1130 matches the receiving ECU ID as an argument. For example, in the data example of FIG. 7, when the receiving ECU ID as the argument is “2”, the required operation accuracy level “2” is acquired.

### (FIG. 18: Step S106001)

The required operation accuracy level determination unit 106 returns the required operation accuracy level field 1132 as a return value, and the present operation flow ends.

FIG. 19 is a flow chart of operation of the data corruption detection method selection unit 107. A similar operation flow is implemented by the data corruption detection method selection unit 207 and the data corruption detection method selection unit 307. In the following, each step of FIG. 19 will be described.

### (FIG. 19: Step S107000)

The data corruption detection method selection unit 107 references the detection method selection table 114 and acquires the value of the data corruption detection method field 1142 from the record of which the value in the receiving-end required operation accuracy level field 1141 is equal to the required operation accuracy level as an argument. For example, in the data example of FIG. 8, when the required operation accuracy level is “2”, the parity data creation unit is selected as the data corruption detection method. Not all of the data corruption detection methods described in the detection method selection table 114 may be implemented on all of the ECUs. The detection method selection table may describe only those data corruption detection methods that are used by all of the ECUs.

### (FIG. 19: Step S107001)

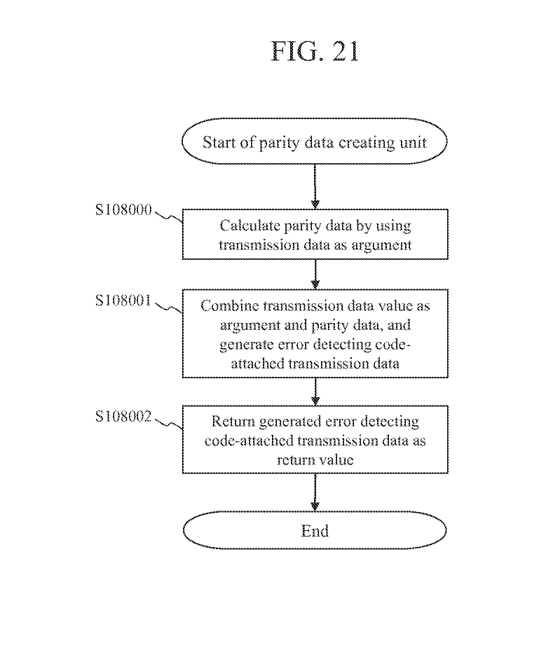

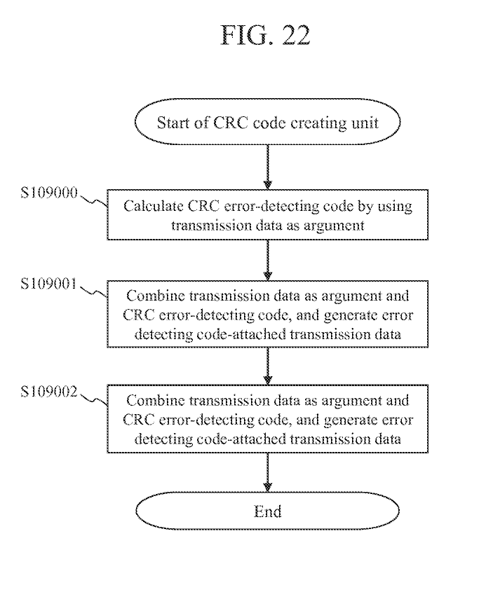

The data corruption detection method selection unit 107, using the transmission data received as the argument, calls the error-detecting code creation unit corresponding to the data corruption detection method selected in step S107000, and acquires error detecting code-attached transmission data as a return value. For example, when the data corruption detection method 1142 selected in step S107000 is the parity data creation unit, the parity data creation unit 108 is called. An example of operation for calling the parity data creation unit 108 in the present step will he described with reference to FIG. 21, and an example of operation for calling the CRC code creation unit 109 will he described with reference to FIG. 22.

### (FIG. 19: Step S107002)

The data corruption detection method selection unit 107 returns the acquired error detecting code-attached transmission data as the return value, and the present operation flow ends.

FIG. 20 illustrates a structure of error detecting code-attached transmission data 510. The error detecting code-attached transmission data 510 includes transmission data 511 and an error-detecting code 512. The transmission data 511 is data calculated by the camera control unit 104, the following distance control unit 204, or the pre-crash safety control unit 304.

Because Embodiment 1 is based on the assumption that CAN is used as the network, the maximum size of the error detecting code-attached transmission data 510 is 8 bytes. However, the present invention is not limited to such an embodiment. When FlexRay is used as the network, for example, the maximum size of the error detecting code-attached transmission data 510 is 254 bytes.

FIG. 21 is a flow chart of operation of the parity data creation unit 108. In the following, each step of FIG. 21 will be described.

### (FIG. 21: Step S108000)

The parity data creation unit 108 calculates parity data by using the transmission data received as an argument.

### (FIG. 21: Step S108001)

The parity data creation unit 108 generates error detecting code-attached transmission data by combining the transmission data as the argument and the parity data calculated in step S108000.

### (FIG. 21: Step S108002)

The parity data creation unit 108 returns the error detecting code-attached transmission data generated in step S108001 as a return value, and the present operation flow ends.

FIG. 22 is a flow chart of operation of the CRC code creation unit 109. A similar operation flow is implemented by the CRC code creation unit 209. In the following, each step of FIG. 22 will be described.

### (FIG. 22: Step S109000)

The CRC code creation unit 109 calculates a CRC error-detecting code by using the transmission data received as an argument.

### (FIG. 22: Step S109001)

The CRC code creation unit 109 generates error detecting code-attached transmission data by combining the transmission data as the argument and the CRC error-detecting code calculated in step S109000.

### (FIG. 22: Step S109002)

The CRC code creation unit 109 returns the error detecting code-attached transmission data generated in step S109001 as a return value, and the present operation flow ends.

FIG. 23 is a flow chart of operation of the communication control unit (transmission process) 110. A similar operation flow is implemented by the communication control unit (transmission process) 210, and the communication control unit (transmission process) 310. In the following, each step of FIG. 23 will be described.

### (FIG. 23: Step S110000)

The communication control unit (transmission process) 110 stores the error detecting code-attached transmission data received as an argument in a mail box of the CAN controller 116.

### (FIG. 23: Step S110001)

The communication control unit (transmission process) 110 sets a transmission request flag of the CAN controller 116, and the present operation flow ends. The CAN controller 116 transmits the data in the mail box corresponding to the transmission request flag that has been set to the CAN bus 5.

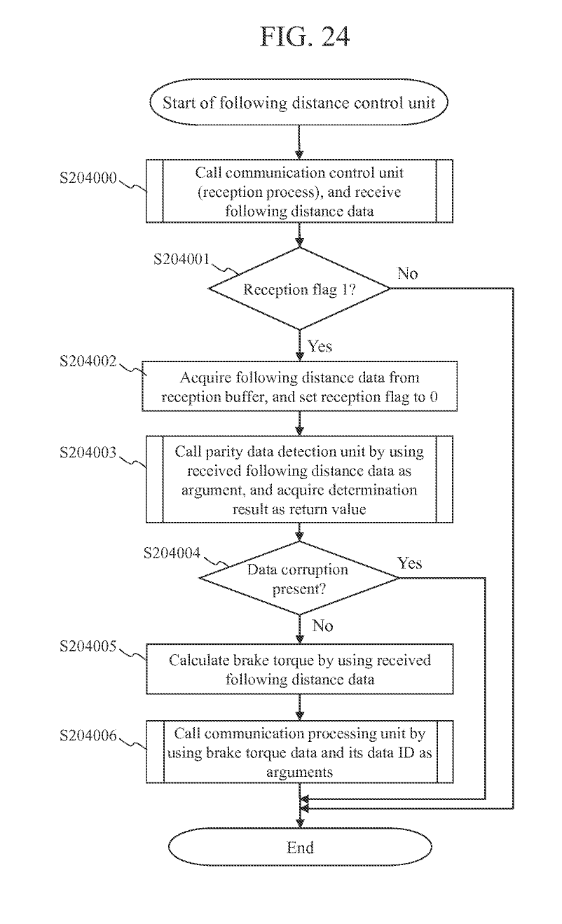

FIG. 24 is a flow chart of operation of the following distance control unit 204 provided in the following distance control ECU 2. In the following, each step of FIG. 24 will be described.

### (FIG. 24: Step S204000)

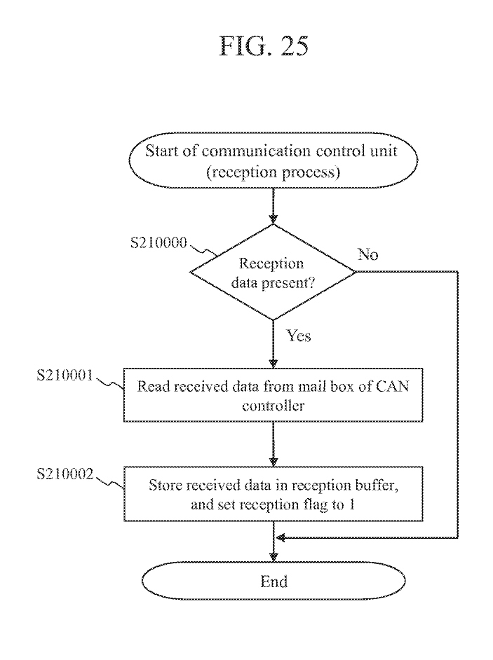

The following distance control unit 204 calls the communication control unit (reception process) 210, and receives the following distance data. The details of the present step will be described with reference to FIG. 25.

### (FIG. 24: Step S204001)

The following distance control unit 204 determines whether the reception flag field 2142 of the reception buffer 214 is “1” indicating reception of the following distance data. If the reception flag field 2142 is “1”, the present operation flow advances to step S204002; if “0”, the operation flow ends.

### (FIG. 24: Step S204002)

The following distance control unit 204 acquires the following distance data retained in the data value field 2141 of the reception buffer 214, and sets the reception flag field 2142 of the same record to “0”.

### (FIG. 24: Step S204003)

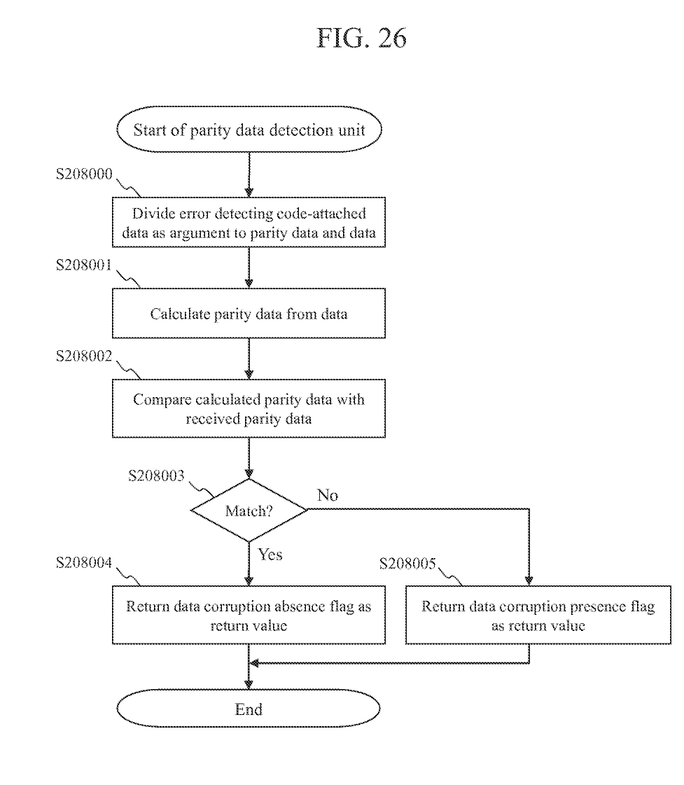

The following distance control unit 204 calls the parity data detection unit 208 by using the following distance data acquired from the reception buffer 214 as an argument, and acquires a determination result as a return value. The details of the present step will be described with reference to FIG. 26.

### (FIG. 24: Step S204004)

The following distance control unit 204 determines whether the determination result acquired in step S204003 indicates the absence of data corruption. If there is no data corruption, the operation flow proceeds to step S204005; if there is data corruption, the operation flow ends.

### (FIG. 24: Step S204005)

The following distance control unit 204 calculates a brake torque required for maintaining a constant following distance by using the received following distance data.

### (FIG. 24: Step S204006)

The following distance control unit 204, using as arguments the calculated brake torque data and the value of the data ID field 2121 (“2” in the data example of FIG. 9) in the communication data management table 212 corresponding to the brake torque data, calls the communication processing unit 205, and the present operation flow ends.

FIG. 25 is a flow chart of operation of the communication control unit (reception process) 210. A similar operation flow is implemented by the communication control unit (reception process) 310 and the communication control unit (reception process) 406. In the following, each step of FIG. 25 will be described.

### (FIG. 25: Step S210000)

The communication control unit. (reception process) 210 determines whether here is reception data by confirming the reception flag of the CAN controller 216. If there is reception data, the present operation flow proceeds to step S210001; if not, the operation flow ends.

### (FIG. 25: Step S210001)

The communication control unit (reception process) 210 reads the reception data from the mail box of the CAN controller 216.

### (FIG. 25: Step S210002)

The communication control unit (reception process) 210 searches the reception buffer 214 for the reception CAN ID field 2140 that is equal to the CAN ID of the received data, and stores the reception data in the data value field 2141. The communication control unit (reception process) 210 sets the value in the reception flag field 2142 of the same record to “1”, and the present operation flow ends.

FIG. 26 is a flow chart of operation of the parity data detection unit 208. In the following, each step of FIG. 26 will be described.

### (FIG. 26: Step S208000)

The parity data detection unit 208 divides the error-detecting code-attached reception data received as an argument into parity data and data, such as the following distance data.

### (FIG. 26: Step S208001)

The parity data. detection unit 208 calculates parity data by using the data acquired in step S208000.

### (FIG. 26: Step S208002)

The parity data detection unit 208 compares the parity data calculated in step S208001 with the parity data received as an argument.

### (FIG. 26: Step S208003)

The parity data detection unit 208 determines whether the parity data calculated in step S208001 and the parity data received as an argument match each other. When the data match, the operation flow proceeds to step S208004; if not, the operation flow proceeds to step S208005.

### (FIG. 26: Step S208004)

The parity data detection unit 208 returns “0” as a return value indicating the absence of data corruption, and the present operation flow ends.

### (FIG. 26: Step S208005)

The parity data detection unit 208 returns “1” as a return value indicating the presence of data corruption, and the operation flow ends.

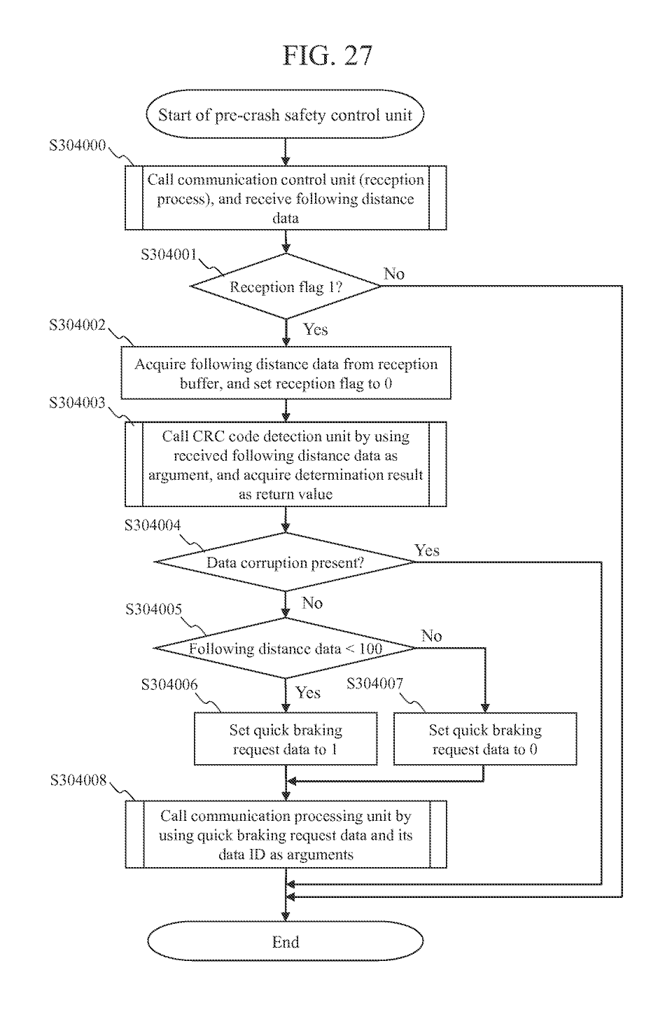

FIG. 27 is a flow chart of operation of the pre-crash safety control unit 304 Provide in the pre-crash safety ECU 3. In the following, each step of FIG. 27 will be described.

### (FIG. 27: Step S304000)

The pre-crash safety control unit 304 calls the communication control unit (reception process) 310, and receives he following distance data.

### (FIG. 27: Step S304001)

The pre-crash safety control unit 304 determines whether the reception flag field 3142 of the reception buffer 314 is “1” indicating reception of the following distance data. If the reception flag field 3142 is “1”, the present operation flow proceeds to step S304002; if the reception flag field 3142 is “0”, the operation flow ends.

### (FIG. 27: Step S304002)

The pre-crash safety control unit 304 acquires the following distance data retained in the data value field 3141 of the reception buffer 314, and sets the reception flag field 3142 of the same record to “0”.

### (FIG. 27: Step S304003)

The pre-crash safety control unit 304 calls the CRC code detection unit 308 by using the received following distance data as an argument, and acquires a determination result as a return value.

### (FIG. 27: Step S304004)

The pre-crash safety control unit 304 determines whether the determination result acquired in step S304003 indicates the absence of data corruption. If there is no data corruption, the operation flow proceeds to step S304005; if there is data corruption, the operation flow ends.

### (FIG. 27: Step S304005)

The pre-crash safety control unit 304 determines Whether the value of the following distance data acquired in step S304002 is greater than 100. If the value is greater than 100, the operation flow proceeds to step S304006; if not more than 100, the operation flow proceeds to step S304007.

### (FIG. 27: Step S304006)

The pre-crash safety control unit 304 sets quick braking request data to “1”. The quick braking request data “1” indicates that the brake control ECU 4 is instructed to implement quick braking.

### (FIG. 27: Step S304007)

The pre-crash safety control unit 304 sets quick braking request data to “0”. The quick braking request data “0” indicates that quick braking is not implemented.

### (FIG. 27: Step S304008)

The pre-crash safety control unit 304 calls the communication processing unit 305 by using as arguments the quick braking request data and the value (which is “3” in the data example of FIG. 12) in the data ID field 3121 of the communication data management table 312 corresponding to the quick braking request data, and the present operation flow ends.

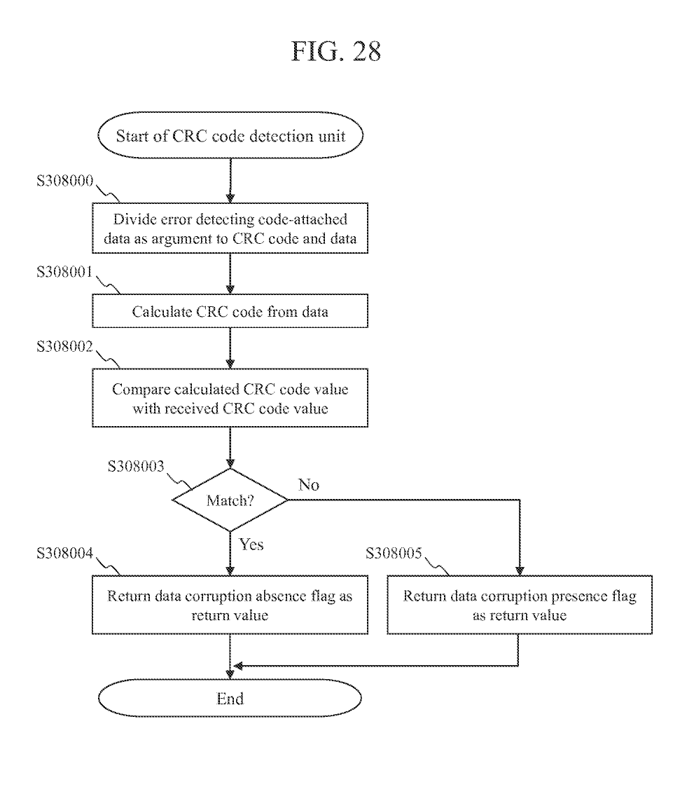

FIG. 28 is a flow chart of operation of the CRC code detection unit 308. A similar operation flow is implemented by the CRC code detection unit 405. In the following, each step of FIG. 28 will be described.

### (FIG. 28: Step S308000)

The CRC code detection unit 308 divides the error detecting code-attached reception data received as an argument into a CRC code and data, such as the following distance data.

### (FIG. 28: Step S308001)

The CRC code detection unit 308 calculates a CRC code by using the data acquired in step S308000.

### (FIG. 28: Step S308002)

The CRC code detection unit 308 compares the CRC code calculated in step S308001 with the CRC code received as an argument.

### (FIG. 28: Step S308003)

The CRC code detection unit 308 determines whether the CRC code calculated in step S308001 and the CRC code received as an argument match each other. When the CRC codes match, the operation flow proceeds to step S308004; if riot, the operation flow proceeds to step S308005.

### (FIG. 28: Step S308004)

The CRC code detection unit 308 returns “0” as a return value indicating the absence of data corruption, and the present operation flow ends.

### (FIG. 28: Step S308005)

The CRC code detection unit 308 returns “1” as a return value indicating the presence of data corruption, and the operation flow ends.

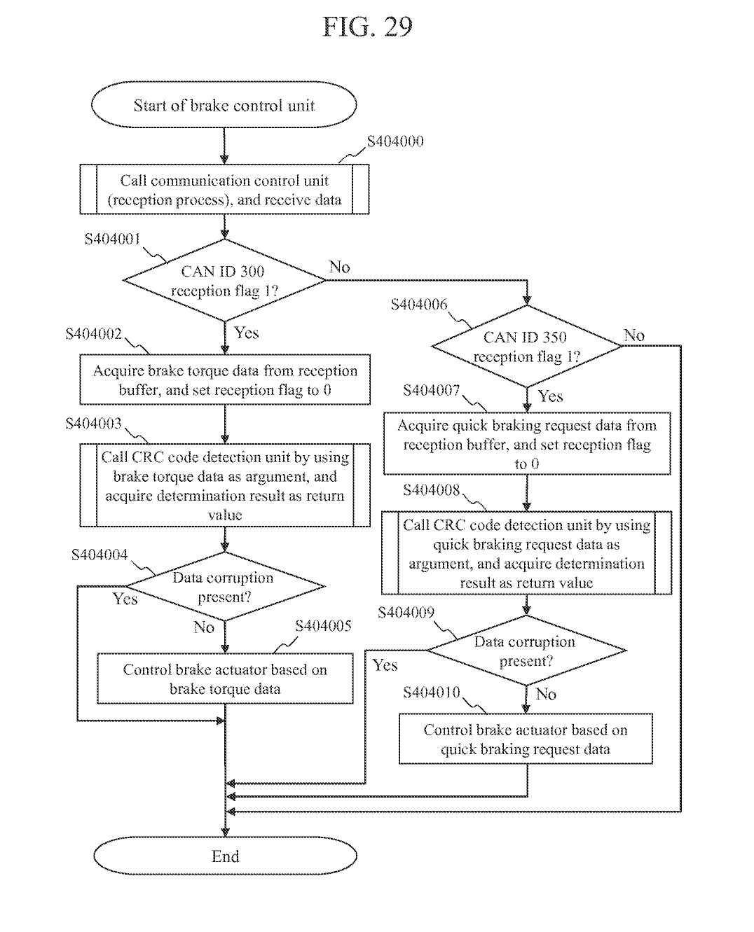

FIG. 29 is a flow chart of operation of the brake control unit 404. In the following, each step of FIG. 29 will be described.

### (FIG. 29: Step S404000)

The brake control lit 404 calls the communication control unit (reception process) 406 and receives data.

### (FIG. 29: Step S404001)

The brake control unit 404 determines whether the reception flag field 4082 of the record of which the reception CAN ID field 4080 of the reception buffer 408 is “300” is “1”. If the reception flag field 4082 is “1”, the operation flow proceeds to step S404002; if not, the operation flow proceeds to step S404006.

### (FIG. 29: Step S404002)

The brake control unit 404 acquires the brake torque data retained in the data value field 4081 of the reception buffer 408, and sets the reception flag field 4082 of the same record to “0”.

### (FIG. 29: Step S404003)

The brake control unit 404 calls the CRC code detection unit 405 by using the received brake torque data as an argument, and acquires a determination result as a return value.

### (FIG. 29: Step S404004)

The brake control unit 404 determines whether the determination result acquired in step S404003 indicates the absence of data corruption. If there is no data corruption, the operation flow proceeds to step S404005; if there is data corruption, the operation flow ends.

### (FIG. 29: Step S404005)

The brake control unit 404 controls the brake actuator 413 based on the received brake torque data, and the present operation flow ends.

### (FIG. 29: Step S404006)

The brake control unit 404 determines whether the reception flag field 4082 of the record of which the reception CAN ID field 4080 of the reception buffer 408 is “350” is “1”. If so, the present operation flow proceeds to step S404007; if not, the operation flow ends.

### (FIG. 29: Step S404007)

The brake control unit 404 acquires the quick braking request data retained in the data value field 4081 of the reception buffer 408, and sets the reception flag field 4082 of the same record to “0”.

### (FIG. 29: Step S404008)

The brake control unit 404 calls the CRC code detection unit 405 by using the received quick braking request data as an argument, and acquires a determination result as a return value.

### (FIG. 29: Step S404009)

The brake control unit 404 determines whether the determination result acquired in step S404008 indicates the absence of data corruption. If there is no data corruption, the present operation flow proceeds to step S404010; if there is data corruption, the operation flow ends.

### (FIG. 29: Step S404010)

The brake control it 404 controls the brake actuator 413 based on the received quick braking request data, and the present operation flow ends.

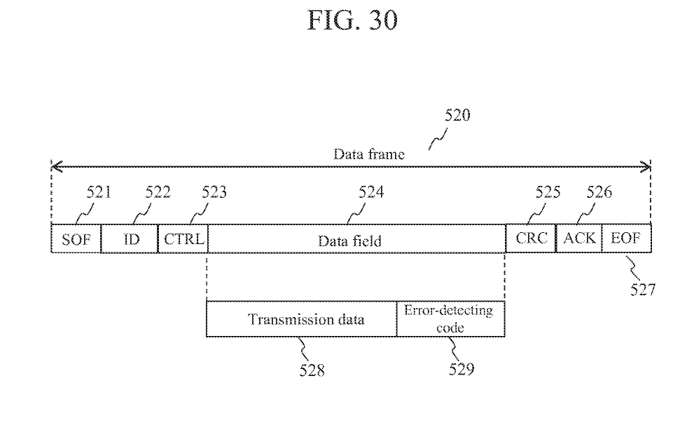

FIG. 30 illustrates a data frame 520 that uses CAN as the communication protocol. The data frame 520 includes an SOF 521 indicating the start of frame, an identifier (ID) 522 enabling unique identification of the frame, a CTRL 523 indicating a size length of the frame, a data field 524 in which transmitted data is stored, a CRC 525 for detecting communication data error, an ACK 526 indicating normal reception, and an EOF 527 indicating the end of frame. The transmission data 511 of the error detecting code-attached transmission data 510 described with reference to FIG. 20 corresponds to transmission data 528, and the error-detecting code 512 corresponds to an error-detecting code 529.

According to Embodiment 1, CAN is adopted as the communication protocol, and the camera control unit 104, the following distance control unit 204, the pre-crash safety control unit 304, and the brake control unit 404 are configured to perform the above processes periodically (such as at 10 ms intervals). Alternatively, each of the ECUs may be configured to implement the respective processes upon reception of control data from another ECU. In the former case, the network connecting the ECUs is a time-triggered network; in the latter case, the network is an event-triggered network.

### Embodiment 1: Summary

As described above, according to Embodiment 1, the camera ECU 1, the following distance control ECU 2, and the pre-crash safety control ECU 3 select the data corruption detection method in accordance with the required operation accuracy level of the receiving ECU. Thus, a data corruption detection rate can be ensured for each ECU with a different required operation accuracy level.

According to Embodiment 1, because the camera ECU 1, the following distance control ECU 2, and the pre-crash safety control ECU 3 select the data corruption detection method in accordance with the required operation accuracy level of the receiving ECU, the size of the error-detecting code can be minimized while the data corruption detection rate is ensured. Thus, the network communication burden can be kept down, and the operating burden on the CPU can be kept down.

According to Embodiment 1, by adding the error-detecting code in the data field portion of the communication packet, data error outside the communication path can be detected. For example, even if the CAN controller 116 is configured to detect a data error on the network by creation the CRC code 525 for the communication packet as a whole, the communication packet upon arrival at an ECU is written in the mail box, and the CRC code 525 is not required anymore. Thus, if a data error is caused in the period between the arrival of the communication packet at the receiving ECU and its retrieval from the mail box, the error cannot be detected. According to Embodiment 1, by creation the error-detecting code in the data field as well, a data error after the arrival of the communication packet at the receiving ECU can be detected.

### Embodiment 2

According to Embodiment 1, the required operation accuracy level is assigned on the ECU basis. However, the present invention is not limited to such an embodiment. For example, the required operation accuracy level is assigned to the function implemented by each ECU using control data. In this case, the required operation accuracy level may be defined for each function of each ECU in the required level determination table 113.

Further, the required operation accuracy level may be assigned to a combination of the data transmitting-end function and the data receiving-end function. In this case, combinations of the transmitting-end functions and the receiving-end functions of the individual ECUs may be described in the required level determination table 113, and the required operation accuracy level may be defined for each combination.

The required operation accuracy level may be assigned to the network bus. In this case, combinations of the receiving ECUs and networks used for transmitting data to the receiving ECUs may be described in the required level determination table 113, and the required operation accuracy level may be defined for each combination.

### Embodiment 3

In Embodiments 1 and 2, the required operation accuracy level of the receiving ECU may be determined without using the required level determination table 113 and the like if that is possible. For example, when a certain operation accuracy level is set for each data type, the required operation accuracy level of the receiving ECU may be determined by using the data ID or the CAN ID.

The present invention is not limited to the foregoing embodiments, and may include various modifications. The foregoing embodiments have been described in detail to facilitate an understanding of the present invention, and the present invention is not necessarily limited to embodiments having all of the configurations described. A part of one embodiment may be substituted by a configuration of another embodiment, or a configuration of the other embodiment may be incorporated into a configuration of the one embodiment. With regard to a part of the configuration of an embodiment, additions, deletions, or substitutions may be made.

For example, the configuration of the tables may not be as per e description made with reference to the drawings as long as the same functions can be implemented. Further, implementation in table format is not necessarily required.

The tables for storing static data, such as the required level determination table 113, may be defined at the time of manufacture of each ECU, or the values retained in the tables may be received via a network during operation and saved.

The configurations, functions, processing units, process means and the like described above may be partly or entirely implemented in the form of hardware, such as an integrated circuit. The configurations, functions and the like described above may be implemented in the form of software, such as a program interpreted and executed by a processor to implement the respective functions. Programs, tables, files, and other information for implementing the respective functions may be stored in a recording unit such as a memory, a hard disk, or a solid state drive (SSD), or in a recording medium such as an IC card, an SD card, or a DVD.

### REFERENCE SIGNS LIST

1: Camera ECU

11: On-board camera

101: Operating unit

102: Memory

103: Program area

104: Camera control unit

105: Communication processing unit

106: Required operation accuracy level determination unit

107: Data corruption detection method selection unit

108: Parity data creation unit

109: CRC code creation unit

110: Communication control unit

111: Data storage area

112: Communication data management table

113: Required level determination table

114: Detection method selection table

115: Input/output circuit

116: CAN controller

117: CRC circuit

118: Signal input/output circuit

2: Following distance control ECU

201: Operating unit

202: Memory

203: Program area

204: Following distance control

205: Communication processing unit

206: Required operation accuracy level determination unit

207: Data corruption detection method selection unit

208: Parity data detection unit

209: CRC code creation unit

210: Communication control unit

211: Data storage area

212: Communication data management table

213: Required level determination table

214: Reception buffer

215: input/output circuit

216: CAN controller

217: CRC circuit

218: Signal input/output circuit

3: Pre-crash safety control ECU

301: Operating unit

302: Memory

303: Program area

304: Pre-crash safety control unit

305: Communication processing unit

306: Required operation accuracy level determination unit

307: Data corruption detection method selection unit

308: CRC code detection unit

309: CRC code creation unit

310: Communication control unit

311: Data storage area

312: Communication data management table

313: Required level determination table

314: Reception buffer

315: Input/output circuit

316: CAN controller

317: CRC circuit

318: Signal input/output circuit

4: Brake control ECU

41: Brake

401: Operating unit

402: Memory

403: Program area

404: Brake control unit

405: CRC code detection unit

406: Communication control unit

407: Data storage area

408: Reception buffer

409: Input/output circuit

410: CAN controller

413: Brake actuator

5: CAN

1000: Automotive control system

1. An automotive control unit comprising:
a communication unit that transmits and receives control data via a network;
an error-detecting code creation unit that provides an error-detecting code for the control data transmitted by the transmitting unit; and
a required operation accuracy level determination unit that determines a required operation accuracy level indicating a required degree of accuracy of operation of a receiving unit that receives the control data,
wherein the error-detecting code creation unit modifies error detection performance of the error-detecting code in accordance with the required operation accuracy level determined by the required operation accuracy level determination unit.

2. The automotive control unit according to claim 1, wherein
the error-detecting code creation unit provides the error-detecting code in a portion of a communication packet transmitted by the communication unit, the portion describing the control data.

3. The automotive control unit according to claim 2, wherein
the communication unit provides, in the communication packet storing the control data having the error-detecting code provided by the error-detecting code creation unit, an error-detecting code different from the error-detecting code provided by the error-detecting code creation unit.

4. The automotive control unit according to claim 1, further comprising a required operation accuracy level table describing a correspondence relationship between the receiving unit and the required operation accuracy level,
wherein
the required operation accuracy level determination unit determines the required operation accuracy level of the receiving unit in accordance with the description in the required operation accuracy level table.

5. The automotive control unit according to claim 1, wherein
the required operation accuracy level determination unit determines the required operation accuracy level for each function performed by the receiving unit using the control data.

6. The automotive control unit according to claim 1, wherein
the required operation accuracy level determination unit determines the required operation accuracy level for each combination of a function performed by the receiving unit using the control data and a function of the automotive control unit.

7. The automotive control unit according to claim 1, wherein
the required operation accuracy level determination unit determines the required operation accuracy level for each combination of the network and the receiving unit.

8. The automotive control unit according to claim 1, further comprising a communication data management table describing a correspondence relationship between the receiving unit that receives the control data and a type of the control data,
wherein
the required operation accuracy level determination unit identifies the receiving unit that receives the control data in accordance with the description in the communication data management table, and determines the required operation accuracy level required in the receiving unit.

9. An automotive control system comprising a plurality of the automotive control units according to claim 1,
wherein the plurality of automotive control units are connected via the network.

10. The automotive control system according to claim 9, wherein
the network is an event-triggered network.

11. The automotive control system according to claim 9, wherein
the network is a time-triggered network.
